(19) United States
(12) Patent Application Publication
(10) Pub. No.: US 2019/0274147 A1
(43) Pub. Date: Sep. 5, 2019

(54) COMMUNICATION METHOD, APPARATUS, AND SYSTEM

(71) Applicant: HUAWEI TECHNOLOGIES CO., LTD., Shenzhen (CN)

(72) Inventors: Mao YANG, Xi'an (CN); Bo LI, Xi'an (CN); Jian YU, Shenzhen (CN)

(21) Appl. No.: 16/418,027

(22) Filed: May 21, 2019

Related U.S. Application Data
(63) Continuation of application No. PCT/CN2017/110821, filed on Nov. 14, 2017.

(30) Foreign Application Priority Data
Nov. 22, 2016 (CN) 201611036985.9

(51) Int. Cl. H04W 72/12; H04W 52/02

(52) U.S. Cl. CPC H04W 72/121; H04W 72/1289; H04W 84/12; H04W 52/0219; H04W 52/0216

(57) ABSTRACT

The present disclosure relates to communication methods, apparatus, and systems. One example method includes sending, by an access point, a first beacon frame, where the first beacon frame is used to schedule a first-type station set, a target wake time (TWT) information element in the first beacon frame includes first indication information, and the first indication information is used to indicate to the first-type station set that a first TWT service period is provided to a second-type station set for use, and sending, by the access point, a second indication frame in the first TWT service period, where the second indication frame is used to schedule the second-type station set, and a bandwidth specification of a physical packet carrying a beacon frame for scheduling the first-type station set is different from a bandwidth specification of a physical packet carrying an indication frame for scheduling the second-type station set.

### CROSS-REFERENCE TO RELATED APPLICATIONS

This application is a continuation of International Application No. PCT/CN2017/110821, filed on Nov. 14, 2017, which claims priority to Chinese Patent Application No. 201611036985.9, filed on Nov. 22, 2016. The disclosures of the aforementioned applications are incorporated herein by reference in their entireties.

### STATEMENT OF JOINT RESEARCH AGREEMENT

The subject matter and the claimed application were made by or on the behalf of Northwestern Polytechnical University, of No. 127, West Youyi Road, Xi'an, Shaanxi 710072, P. R. China and Huawei Technologies Co., Ltd., of Shenzhen, Guangdong Province, P. R. China, under a joint research agreement titled “Technical and development consulting Services Agreement”. The joint research agreement was in effect on or before the claimed application was made, and the claimed application was made as a result of activities undertaken within the scope of the joint research agreement.

### TECHNICAL FIELD

This application relates to the communications field, and in particular, to a communication method, an apparatus, and a system.

### BACKGROUND

With rapid development of the Internet of Things (Internet of Things, IoT), connection of things has become an inevitable trend of wireless network development. As a primary manner of bearing wireless data, a wireless local area network (Wireless Local Area Network, WLAN) also needs to support station operation and bear services in the Internet of Things in a future development and evolution process. When the IoT and a next-generation WLAN share a frequency band or even share a system, advantages such as convenient deployment and low costs can be gained, and a new business mode can arise therefrom. However, an Internet of Things station usually operates on a narrowband, and a WLAN station (from example, stations in the communications standards 802.11ax, 802.11ac, 802.11n, 802.11g, 802.11b, and 802.11a) operates on a broadband. This affects coexistence of the Internet of Things station and the WLAN station in frequency domain. In the prior art, mutual interference between the Internet of Things station and the WLAN station cannot be effectively coordinated.

### SUMMARY

This application provides a communication method, an apparatus, and a system, to achieve compatibility between different types of stations during communication and reduce mutual interference between different types of stations.

According to a first aspect, a communication method is provided, including: sending, by an access point, a first beacon frame, where the first beacon frame is used to schedule a first-type station set, a target wake time TWT information element in the first beacon frame includes first indication information, and the first indication information is used to indicate to the first-type station set that a first TWT service period is provided to a second-type station set for use; and sending, by the access point, a second indication frame in the first TWT service period, where the second indication frame is used to schedule the second-type station set, and a bandwidth specification of a physical packet carrying a beacon frame for scheduling the first-type station set is different from a bandwidth specification of a physical packet carrying an indication frame for scheduling the second-type station set.

The access point indicates, to the first-type station set in the first beacon frame, the first TWT service period in which the second-type station set operates; and sends, to the second-type station set in the first TWT service period, the second indication frame for scheduling the second-type station set, so that the first-type station set avoids an operating time of the second-type station set, thereby preventing the two types of stations from interfering with each other and improving communication quality.

In a possible implementation, before the sending, by the access point, a second indication frame, the communication method further includes: sending, by the access point, a control signal through a channel used by the first-type station set, where the control signal is used to indicate to the first-type station set that the channel is occupied in a second time, and the second time includes the first TWT service period.

To further ensure that the second-type station set is not interfered with by the first-type station set during the operating time, the access point may send, before sending the second indication frame, the control signal through the channel used by the first-type station set, to occupy the channel, so that a first-type station cannot transmit data through the channel, thereby ensuring that a second-type station can send the second indication frame and other data through the channel without being interfered with.

In a possible implementation, the control signal is control information, and the control information is carried in a preamble.

In a possible implementation, the control signal is used to set a network allocation vector, and the network allocation vector is set to “occupy the channel in the second time”.

In a possible implementation, the control signal includes any one of the following signals: a request to send RTS frame, a multi-user request to send MU-RTS frame, and a clear to send-to-self frame.

In a possible implementation, the second indication frame includes second indication information, and the second indication information is used to indicate a transmission period of an indication frame for scheduling the second-type station set.

In a possible implementation, the second indication frame includes third indication information, and the third indication information is used to indicate a transmission time of a next indication frame for scheduling the second-type station set.

In a possible implementation, the next indication frame and the second indication frame are separated by at least one beacon frame, and the at least one beacon frame is a beacon frame for scheduling the first-type station set.

In a possible implementation, the second indication frame includes fourth indication information, and the fourth indication information is used to indicate to the second-type station set that a second TWT service period is provided to the first-type station set for use.

In a possible implementation, the second-type station set includes an Internet of Things station.

In a possible implementation, a bandwidth of a physical packet carrying the first beacon frame is greater than or equal to 20 MHz, and a bandwidth of a physical packet carrying the second indication frame is less than 20 MHz.

According to a second aspect, a communication method is provided, where the communication method may be performed by a station in a first-type station set, and includes: receiving, by the station in the first-type station set, a first beacon frame sent by an access point, where the first beacon frame is used to schedule the first-type station set, a target wake time TWT information element in the first beacon frame includes first indication information, the first indication information is used to indicate to the first-type station set that a first TWT service period is provided to a second-type station set for use, and a bandwidth specification of a physical packet carrying a beacon frame for scheduling the first-type station set is different from a bandwidth specification of a physical packet carrying an indication frame for scheduling the second-type station set; and performing, by the station, communication based on the first beacon frame.

The access point indicates, to the first-type station set in the first beacon frame, the first TWT service period in which the second-type station set operates, so that the first-type station set avoids an operating time of the second-type station set, thereby preventing the two types of stations from interfering with each other and improving communication quality.

In a possible implementation, the communication method further includes: receiving, by the station through a channel used by the first-type station set, a control signal sent by the access point, where the control signal is used to indicate to the first-type station set that the channel is occupied in a second time, and the second time includes the first TWT service period.

In a possible implementation, the control signal is control information, and the control information is carried in a preamble.

In a possible implementation, the control signal is used to set a network allocation vector, and the network allocation vector is set to “occupy the channel in the second time”.

In a possible implementation, the control signal includes any one of the following signals: a request to send RTS frame, a multi-user request to send MU-RTS frame, and a clear to send-to-self frame.

In a possible implementation, the second-type station set includes an Internet of Things station.

According to a third aspect, a communication method is provided, where the method may be performed by a station in a second-type station set, and includes:

receiving, by the station in the second-type station set, a second indication frame sent by an access point, where the second indication frame is used to schedule the second-type station set, the second indication frame includes fourth indication information, the fourth indication information is used to indicate to the second-type station set that a second TWT service period is provided to a first-type station set for use, and a bandwidth specification of a physical packet carrying a beacon frame for scheduling the first-type station set is different from a bandwidth specification of a physical packet carrying an indication frame for scheduling the second-type station set; and performing, by the station, communication based on the second indication frame.

The access point indicates, in the second indication frame, to the second-type station set that the first-type station set operates in the second TWT service period, so that the second-type station set avoids an operating time of the first-type station set, thereby preventing the two types of stations from interfering with each other and improving communication quality.

In a possible implementation, the second indication frame includes second indication information, and the second indication information is used to indicate a transmission period of an indication frame for scheduling the second-type station set.

In a possible implementation, the second indication frame includes third indication information, and the third indication information is used to indicate a transmission time of a next indication frame for scheduling the second-type station set.

In a possible implementation, the second-type station set includes an Internet of Things station.

In a possible implementation, a bandwidth of a physical packet carrying the second indication frame is less than 20 MHz.

According to a fourth aspect, a communication method is provided, where the method may be performed by an access point, and includes:

sending, by the access point, a first beacon frame, where the first beacon frame is used to schedule a first-type station set; and sending, by the access point, a second indication frame a first time later after sending the first beacon frame, where the second indication frame is used to schedule a second-type station set, the first time is less than a time required by the first-type station set to send data, and a bandwidth specification of a physical packet carrying a beacon frame for scheduling the first-type station set is different from a bandwidth specification of a physical packet carrying an indication frame for scheduling the second-type station set.

To prevent the access point from being interfered with by the first-type station set when sending the second indication frame to the second-type station set, the access point sends the second indication frame to the second-type station set the first time later after sending the first beacon frame to the first-type station set. The first time is less than the time required by the first-type station set to send data. Therefore, after the first time, there is not enough time for the first-type station set to send data to the access point. In this case, a channel cannot be used by a second-type station. Therefore, the access point sends the second indication frame to the second-type station set the first time later, so that it can be ensured that the second-type station set receives the second indication frame without being interfered with by the first-type station set.

In a possible implementation, before the sending, by the access point, a second indication frame, the communication method further includes: sending, by the access point, a control signal through a channel used by the first-type station set, where the control signal is used to indicate to the first-type station set that the channel is occupied in a second time, and the second time includes a time used by the access point to send the second indication frame.

In a possible implementation, the control signal is control information, and the control information is carried in a preamble.

In a possible implementation, the control signal is used to set a network allocation vector, and the network allocation vector is set to “occupy the channel in the second time”.

In a possible implementation, the control signal includes any one of the following signals: a request to send RTS frame, a multi-user request to send MU-RTS frame, and a clear to send-to-self frame.

In a possible implementation, a transmission period of an indication frame for scheduling the second-type station set is N times a transmission period of a beacon frame for scheduling the first-type station set, where N is a positive integer greater than 1.

In a possible implementation, the second indication frame includes fifth indication information, and the fifth indication information is used to indicate, to the second-type station set, a transmission time of a beacon frame for scheduling the first-type station set.

In a possible implementation, the second indication frame includes sixth indication information, and the sixth indication information is used to indicate, to the second-type station set, a communication time range of the first-type station set.

In a possible implementation, the second-type station set includes an

Internet of Things station.

According to a fifth aspect, a communication method is provided, including: receiving, by a station in a second-type station set, a second indication frame sent by an access point, where the second indication frame is used to schedule the second-type station set, the second indication frame includes fifth indication information, the fifth indication information is used to indicate, to the second-type station set, a transmission time of a beacon frame for scheduling a first-type station set, and a bandwidth specification of a physical packet carrying a beacon frame for scheduling the first-type station set is different from a bandwidth specification of a physical packet carrying an indication frame for scheduling the second-type station set; and performing, by the station, communication based on the second indication frame.

The access point indicates, to the second-type station set in the second indication frame, the transmission time of the beacon frame for scheduling the first-type station set, so that the second-type station set avoids a time in which the first-type station set receives the beacon frame, thereby preventing the two types of stations from interfering with each other and improving communication quality.

In a possible implementation, the second indication frame includes sixth indication information, and the sixth indication information is used to indicate, to the second-type station set, a communication time range of the first-type station set.

In a possible implementation, the second-type station set includes an Internet of Things station.

According to a sixth aspect, an access point is provided, and is configured to perform the method according to any one of the first aspect or the possible implementations of the first aspect. Specifically, the access point includes units configured to perform the method according to any one of the first aspect or the possible implementations of the first aspect.

According to a seventh aspect, a station is provided, and is configured to perform the method according to any one of the second aspect or the possible implementations of the second aspect. Specifically, the station includes units configured to perform the method according to any one of the second aspect or the possible implementations of the second aspect.

According to an eighth aspect, another station is provided, and is configured to perform the method according to any one of the third aspect or the possible implementations of the third aspect. Specifically, the station includes units configured to perform the method according to any one of the third aspect or the possible implementations of the third aspect.

According to a ninth aspect, another access point is provided, and is configured to perform the method according to any one of the fourth aspect or the possible implementations of the fourth aspect. Specifically, the access point includes units configured to perform the method according to any one of the fourth aspect or the possible implementations of the fourth aspect.

According to a tenth aspect, another station is provided, and is configured to perform the method according to any one of the fifth aspect or the possible implementations of the fifth aspect. Specifically, the station includes units configured to perform the method according to any one of the fifth aspect or the possible implementations of the fifth aspect.

According to an eleventh aspect, an access point is provided, where the access point includes a communications interface, a memory, a processor, and a bus system. The communications interface, the memory, and the processor are connected by using the bus system. The memory is configured to store an instruction. The processor is configured to execute the instruction stored in the memory, to control the communications interface to receive a signal and/or send a signal. In addition, when the processor executes the instruction stored in the memory, the processor performs the method according to any one of the first aspect or the possible implementations of the first aspect.

According to a twelfth aspect, a station is provided, where the station includes a communications interface, a memory, a processor, and a bus system. The communications interface, the memory, and the processor are connected by using the bus system. The memory is configured to store an instruction. The processor is configured to execute the instruction stored in the memory, to control the communications interface to receive a signal and/or send a signal. In addition, when the processor executes the instruction stored in the memory, the processor performs the method according to any one of the second aspect or the possible implementations of the second aspect.

According to a thirteenth aspect, another station is provided, where the station includes a communications interface, a memory, a processor, and a bus system. The communications interface, the memory, and the processor are connected by using the bus system. The memory is configured to store an instruction. The processor is configured to execute the instruction stored in the memory, to control the communications interface to receive a signal and/or send a signal. In addition, when the processor executes the instruction stored in the memory, the processor performs the method according to any one of the third aspect or the possible implementations of the third aspect.

According to a fourteenth aspect, an access point is provided, where the access point includes a communications interface, a memory, a processor, and a bus system. The communications interface, the memory, and the processor are connected by using the bus system. The memory is configured to store an instruction. The processor is configured to execute the instruction stored in the memory, to control the communications interface to receive a signal and/or send a signal. In addition, when the processor executes the instruction stored in the memory, the processor performs the method according to any one of the fourth aspect or the possible implementations of the fourth aspect.

According to a fifteenth aspect, a station is provided, where the station includes a communications interface, a memory, a processor, and a bus system. The communications interface, the memory, and the processor are connected by using the bus system. The memory is configured to store an instruction. The processor is configured to execute the instruction stored in the memory, to control the communications interface to receive a signal and/or send a signal. In addition, when the processor executes the instruction stored in the memory, the processor performs the method according to any one of the fifth aspect or the possible implementations of the fifth aspect.

According to a sixteenth aspect, a communications system is provided, where the communications system includes the access point according to any one of the sixth aspect or the possible implementations of the sixth aspect, the station according to any one of the seventh aspect or the possible implementations of the seventh aspect, and the station according to any one of the eighth aspect or the possible implementations of the eighth aspect; or

the system includes the access point according to any one of the eleventh aspect or the possible implementations of the eleventh aspect, the station according to any one of the twelfth aspect or the possible implementations of the twelfth aspect, and the station according to any one of the thirteenth aspect or the possible implementations of the thirteenth aspect.

According to a seventeenth aspect, a communications system is provided, where the communications system includes the access point according to any one of the ninth aspect or the possible implementations of the ninth aspect and the station according to any one of the tenth aspect or the possible implementations of the tenth aspect; or

the system includes the access point according to any one of the fourteenth aspect or the possible implementations of the fourteenth aspect and the station according to any one of the fifteenth aspect or the possible implementations of the fifteenth aspect.

According to an eighteenth aspect, a computer readable medium is provided, and is configured to store a computer program, where the computer program includes an instruction for performing the method according to any one of the first aspect or the possible implementations of the first aspect.

According to a nineteenth aspect, a computer readable medium is provided, and is configured to store a computer program, where the computer program includes an instruction for performing the method according to any one of the second aspect or the possible implementations of the second aspect.

According to a twentieth aspect, a computer readable medium is provided, and is configured to store a computer program, where the computer program includes an instruction for performing the method according to any one of the third aspect or the possible implementations of the third aspect.

According to a twenty-first aspect, a computer readable medium is provided, and is configured to store a computer program, where the computer program includes an instruction for performing the method according to any one of the fourth aspect or the possible implementations of the fourth aspect.

According to a twenty-second aspect, a computer readable medium is provided, and is configured to store a computer program, where the computer program includes an instruction for performing the method according to any one of the fifth aspect or the possible implementations of the fifth aspect.

### BRIEF DESCRIPTION OF DRAWINGS

FIG. 1 is a schematic diagram of an application scenario according to an embodiment of this application;

FIG. 2 is a schematic flowchart of a communication method according to an embodiment of this application;

FIG. 3 is a schematic diagram of a format of a part of a TWT information element according to an embodiment of this application;

FIG. 4 is a schematic flowchart of a communication method according to another embodiment of this application;

FIG. 5 is a schematic flowchart of a communication method according to still another embodiment of this application;

FIG. 6 is a schematic flowchart of a communication method according to yet another embodiment of this application;

FIG. 7 is a schematic diagram of an access point according to an embodiment of this application;

FIG. 8 is a schematic diagram of a station according to an embodiment of this application;

FIG. 9 is a schematic diagram of a station according to another embodiment of this application;

FIG. 10 is a schematic diagram of an access point according to another embodiment of this application;

FIG. 11 is a schematic diagram of a station according to another embodiment of this application;

FIG. 12 is a schematic diagram of an access point according to still another embodiment of this application;

FIG. 13 is a schematic diagram of a station according to still another embodiment of this application;

FIG. 14 is a schematic diagram of a station according to still another embodiment of this application;

FIG. 15 is a schematic diagram of an access point according to yet another embodiment of this application; and

FIG. 16 is a schematic diagram of a station according to yet another embodiment of this application.

### DESCRIPTION OF EMBODIMENTS

The following describes the technical solutions in the embodiments of this application with reference to the accompanying drawings in the embodiments of this application.

It should be understood that the solutions of the embodiments of this application may be applied to a case in which a WLAN shares a channel with another type of network. For example, the solutions may be applied to a case in which the WLAN shares a channel with the Internet of Things. Currently, a standard used by the WLAN is the Institute of Electrical and Electronics Engineers (Institute of Electrical and Electronics Engineers, IEEE) 802.11 series. The WLAN may include a plurality of basic service sets (Basic Service Set, BSS). Network nodes in a BSS may also be referred to as a station (Station, STA) and an access point (Access Point, AP). Each BSS may include one access point and a plurality of stations associated with the access point.

An access point in the embodiment of this application may also be referred to as a wireless access point, a hotspot, or the like. The access point is an access point for a mobile user to access a wired network, and is mainly deployed in a home, inside a building, and inside a campus. A typical coverage radius ranges from dozens of meters to hundreds of meters. Certainly, the access point may be deployed outdoors. The access point is equivalent to a bridge that connects a wired network and a wireless network. A main function of the access point is to connect various wireless network clients together and then connect the wireless network to an Ethernet. Specifically, the access point may be a terminal device or a network device that has a Wireless Fidelity (Wireless Fidelity, Wi-Fi) chip. Optionally, the access point may be a device that supports an 802.11ax standard. Further, optionally, the access point may be a device that supports a plurality of WLAN standards such as 802.11ac, 802.11n, 802.11g, 802.11b, and 802.11a, or a subsequent version.

A station in the embodiments of this application is described. However, the station is not limited thereto. The station may be a wireless communications chip, a wireless sensor, or a wireless communications terminal. For example, the station may be a mobile phone supporting a Wi-Fi communication function, a tablet computer supporting a Wi-Fi communication function, a set top box supporting a Wi-Fi communication function, a smart TV supporting a Wi-Fi communication function, a smart wearable device supporting a Wi-Fi communication function, an in-vehicle communications device supporting a Wi-Fi communication function, and a computer supporting a Wi-Fi communication function. Optionally, the station may support an 802.11ax standard. Further, optionally, the station supports a plurality of WLAN standards such as 802.11ac, 802.11n, 802.11g, 802.11b, and 802.11a, or a subsequent version.

As described above, a conflict and mutual interference may occur in a scenario in which a WLAN station coexists with an Internet of Things station. The prior art lacks an efficient coordination and mutual avoidance mechanism. The embodiments of this application provide a mechanism to enable the WLAN station and the Internet of Things station to perform access at different times, thereby reducing power consumption of the stations while reducing conflicts.

The embodiments of this application provide a communication method, an apparatus, and a communications system. A core idea of the method is as follows: When a first-type station set and a second-type station set share a channel, an operating time of the second-type station set may be indicated, to the first-type station set, in a beacon frame for scheduling the first-type station set, so that the first-type station set avoids the operating time of the second-type station set during communication, thereby avoiding mutual interference and improving communication quality.

Similarly, an operating time of the first-type station set may also be indicated in an indication frame for scheduling the second-type station set, to avoid mutual interference.

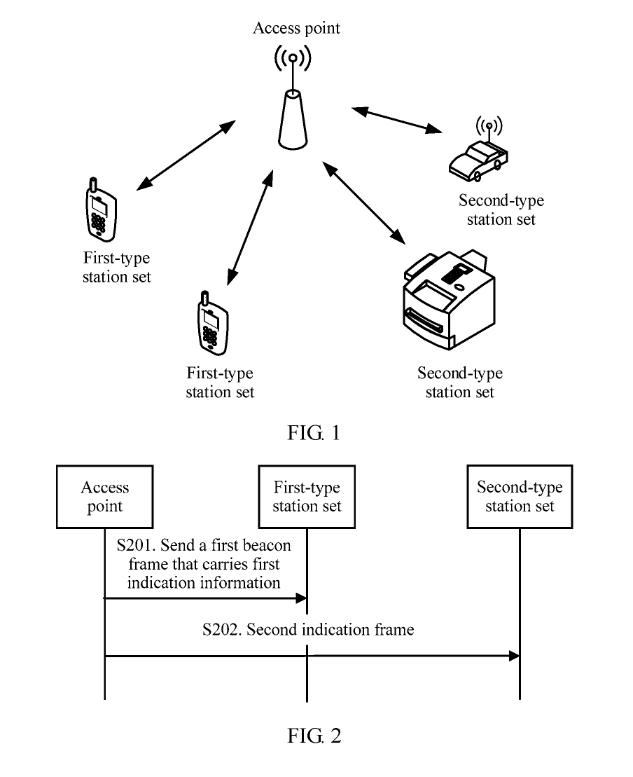

FIG. 1 is a schematic diagram of an application scenario according to an embodiment of this application. As shown in FIG. 1, an access point may schedule a first-type station set and a second-type station set in a coverage area of the access point. The first-type station set and the second-type station set may share a resource in a same frequency domain. In addition, a specification of a physical packet bandwidth at which the first-type station set operates is different from a specification of a physical packet bandwidth at which the second-type station set operates. The two different types of stations share the resource in the same frequency domain. Therefore, to prevent the two types of stations from interfering with each other during communication, the two types of stations perform communication by performing access at different times. The two types of station may enter a sleep state when not performing communication, to reduce power consumption.

Optionally, the first-type station set in FIG. 1 may be a WLAN station set, and the second-type station set in FIG. 1 may be an Internet of Things station set. The WLAN station may be a station in an 802.11ax standard or another standard in the 802.11 series for a wireless local area network. A first beacon frame may be a beacon frame in an 801.11ax standard or another standard in the 802.11 series.

FIG. 2 is a schematic flowchart of a communication method 200 according to an embodiment of this application. The method 200 may be applied to the application scenario in FIG. 1. The method 200 includes the following steps.

S201. An access point sends a first beacon frame, where the first beacon frame is used to schedule a first-type station set, a target wake time (Target Wake Time, TWT) information element (Information element, IE) in the first beacon frame includes first indication information, and the first indication information is used to indicate to the first-type station set that a first TWT service period (Service period, SP) is provided to a second-type station set for use. Optionally, the first beacon frame may be borne and sent by using a data packet of a none high throughput (None High Throughput, non-HT), high throughput (High Throughput, HT), very high throughput (Very High Throughput, VHT), or high efficient (High Efficient, HE) version.

Optionally, after receiving the first beacon frame, a station in the first-type station set may choose not to perform communication in the first TWT service period, to avoid interference and a conflict with a second-type station. Further, the first-type station set may sleep in the first TWT service period, to reduce power consumption.

Optionally, the first-type station set may be a set including a WLAN station, and the second-type station set may be a set including an Internet of Things station. For example, the WLAN station may be a station in an 802.11ax standard for a wireless local area network. The first beacon frame may be a beacon frame in an 801.11ax standard.

Optionally, there may be a plurality of manners of bearing the first indication information in the TWT information element. In a manner, a TWT flow identifier (Flow Identifier) field may be set in the TWT information element, and the TWT flow identifier field is set to indicate that a TWT service period is an operating time the second-type station set.

Optionally, when an indication frame for scheduling the second-type station set is sent periodically, the first indication information may further indicate a transmission period of an indication frame for scheduling the second-type station set, so that the first-type station set calculates, based on the transmission period of the indication frame, a transmission time of the indication frame for scheduling the second-type station set and avoids the transmission time.

S202. The access point sends a second indication frame in the first TWT service period, where the second indication frame is used to schedule the second-type station set, and a bandwidth specification of a physical packet carrying a beacon frame for scheduling the first-type station set is different from a bandwidth specification of a physical packet carrying an indication frame for scheduling the second-type station set.

Optionally, the second indication frame may be a beacon frame redefined for the second-type station set. The second indication frame may have Media Access Control (Media Access Control, MAC) frame content different from that of the beacon frame for scheduling the first-type station set, or the second indication frame may bear a physical layer packet different from that carrying the beacon frame for scheduling the first-type station set. An indication frame for scheduling the second-type station set may also be referred to as a beacon frame or may be in another name. This embodiment of this application sets no limitation thereto. A main function of the second indication frame is to broadcast scheduling information to an Internet of Things station in a cell covered by the access point. The second indication frame may be another management frame or a trigger frame.

Optionally, that a bandwidth specification of a physical packet carrying a beacon frame for scheduling the first-type station set is different from a bandwidth specification of a physical packet carrying an indication frame for scheduling the second-type station set may also be understood as follows: A specification of a physical packet bandwidth at which the first-type station set operates is different from a specification of a physical packet bandwidth at which the second-type station set operates. For example, when the first-type station is a WLAN station set and the second-type station set is an Internet of Things station set, a specification of a physical packet bandwidth at which a WLAN station operates may be greater than or equal to 20 MHz, and a specification of a physical packet bandwidth at which an Internet of Things station operates may be less than 20 MHz.

Optionally, the second indication frame may be indication frames, on a plurality of different frequency bands, for scheduling the second-type station set. In the first TWT service period, the access point may simultaneously send, on a plurality of different frequency bands, indication frames for scheduling the second-type station set; may send, on different frequency bands at different times, that is, at a time interval, indication frames for scheduling the second-type station set; or may use a manner that combines the two methods.

In this embodiment of this application, the access point indicates, to the first-type station set in the first beacon frame, the first TWT service period in which the second-type station set operates; and sends, to the second-type station set in the first TWT service period, the second indication frame for scheduling the second-type station set, so that the first-type station set avoids an operating time of the second-type station set, thereby preventing the two types of stations from interfering with each other and improving communication quality.

Optionally, there may be a first-type station that does not receive the first beacon frame and that transmits data in the first TWT service period. To further ensure that the second-type station set is not interfered with by the first-type station set during the operating time, before sending the second indication frame, the access point may send a control signal through a channel used by the first-type station set, to occupy the channel, so that the first-type station cannot transmit data through the channel, thereby ensuring that the second-type station sends the second indication frame and other data through the channel without being interfered with.

Optionally, in an example, in the communication method 200, before the access point sends the second indication frame, the communication method 200 further includes the following: The access point sends a control signal through a channel used by the first-type station set. The control signal is used to indicate to the first-type station set that the channel is occupied in a second time, and the second time includes the first TWT service period.

Optionally, there may be a plurality of methods for occupying the channel.

In a manner, the control signal may be carried in a preamble. For example, the preamble may be control information in a legacy preamble (English: legacy preamble). For example, the control information may be located in a length field of the legacy preamble. When the first-type station is a WLAN station, the legacy preamble may be a legacy preamble compatible with a WLAN technology.

In another manner, the control signal may be used to set a network allocation vector (Network Allocation Vector, NAV), and the network allocation vector is set to “occupy the channel in the second time”.

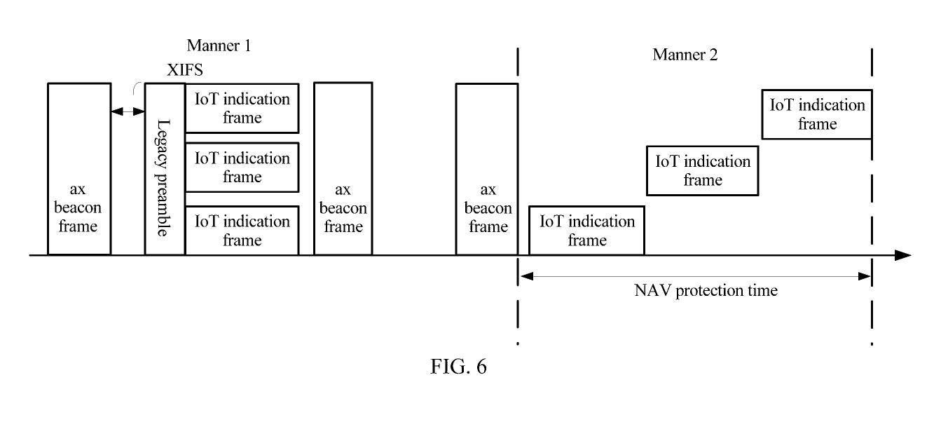

Optionally, the control signal used to set the NAV may be of a plurality of types. For example, the control signal may be any one of the following signals: a request to send (Request to Send, RTS) frame, a multi-user request to send (Multi-user RTS, MU-RTS) frame, and a clear to send-to-self (Clear to Send-to-self, CTS-to-self) frame. Optionally, the first beacon frame may also be used to set an NAV protection time, as shown in FIG. 6.

Optionally, the second indication frame may further indicate, to the second-type station set, a transmission time of a next indication frame for scheduling the second-type station set.

Specifically, there are at least two manners of sending an indication frame for scheduling the second-type station set. A first transmission manner is periodic transmission. A second transmission manner is temporary transmission. In the first transmission manner, that is, periodic transmission, the second indication frame may include second indication information, and the second indication information is used to indicate a transmission period of an indication frame for scheduling the second-type station set. After receiving the second indication frame, a station in the second-type station set may calculate, based on a time at which the second indication frame is received and the transmission period, a subsequent transmission time of the indication frame for scheduling the second-type station set. In the second transmission manner, that is, temporary transmission, the second indication frame may include third indication information, and the third indication information is used to indicate a transmission time of a next indication frame for scheduling the second-type station set. Optionally, the next indication frame and the second indication frame may be separated by at least one beacon frame for scheduling the first-type station set, so that the access point indicates the transmission time of the next indication frame to the first-type station set by using the at least one beacon frame, thereby ensuring that the first-type station set effectively avoids a communication time of the second-type station set. Further, the first-type station set may sleep during the communication time of the second-type station set, to save energy.

Optionally, the second indication frame may also indicate a communication time of the first-type station set to the second-type station set, so that the second-type station set avoids the communication time.

For example, the second indication frame includes fourth indication information, and the fourth indication information is used to indicate to the second-type station set that a second TWT service period is provided to the first-type station set for use.

Optionally, in an example, the second indication frame may further indicate, to the second-type station set, a transmission time or a transmission period of a beacon frame for scheduling the first-type station set, so that the second-type station set calculates, based on the transmission time or the transmission period, a transmission time of a next beacon frame for scheduling the first-type station set and effectively avoids the transmission time.

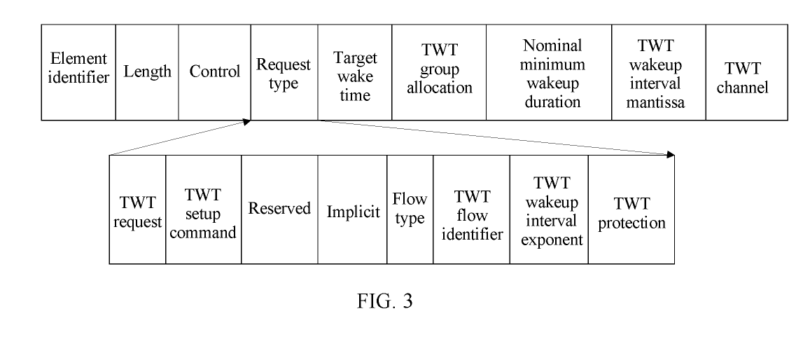

In a specific embodiment, FIG. 3 is a schematic diagram of a format of a part of a TWT information element. As shown in FIG. 3, a new flow identifier type number may be defined in a TWT flow identifier section of the TWT information element. The newly defined flow identifier type number is used to indicate that a TWT service period is a TWT service period used by a second-type station set. For example, when the second-type station set is an Internet of Things station set, it may be defined as follows: when the flow identifier type number is 100, a TWT service period corresponding to the flow identifier type number is an Internet of Things TWT service period.

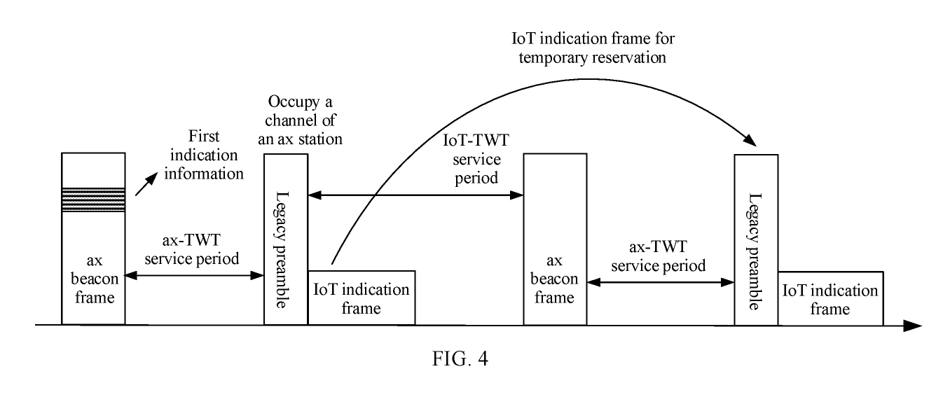

In a specific embodiment, FIG. 4 shows a communication method 400 according to an embodiment of this application. In the communication method 400, it is assumed that a first-type station is a station in an 801.11ax standard (referred to as an ax station for short) and that a second-type station is an Internet of Things station (referred to as an IoT station for short). In this case, a beacon frame for scheduling the first-type station set may be referred to as an ax beacon frame, and an indication frame for scheduling the second-type station set may be referred to as an IoT indication frame. The IoT indication frame may be a beacon frame or a trigger frame. The ax station uses a broadband to perform transmission, and the IoT station uses a narrowband to perform transmission. The communication method 400 includes the following steps:

S401. An access point sends an ax beacon frame, where the ax beacon frame carries TWT information element. A type number in a flow identifier field included in the TWT information element is used to indicate that a first TWT service period is an IoT service period, that is, the first TWT service period is an operating time of the IoT station. The access point sends an IoT indication frame to the IoT station in the first TWT service period. The IoT indication frame herein may be a beacon frame redefined for the IoT station. The IoT indication frame has MAC frame content different from that of the ax beacon frame, or the IoT indication frame bears a physical layer packet different from that carrying the ax beacon frame. For example, a bandwidth of the physical layer packet carrying the ax beacon frame may be greater than or equal to 20 MHz, but a bandwidth of the physical layer packet carrying the IoT indication frame may be less than 20 MHz. The IoT indication frame may be referred to as a beacon frame or may be in another name. A main function of the IoT indication frame is to broadcast scheduling information to all IoT stations in a whole cell. The IoT indication frame may be another management frame or may be implemented by using a trigger frame.

S402. The access point sends, in the first TWT service period designated and provided to the IoT station in S401, a preamble compatible with the ax station through a channel (for example, a channel of 20 MHz or over 20 MHz) used by the ax station, to occupy the channel used by the ax station, so that the ax station does not cause interference to data transmission between the access point and the IoT station in the first TWT service period. Optionally, the access point may send an RTS frame, an MU-RTS frame, or a CTS-to-self frame to set a network allocation vector, to occupy the channel used by the ax station.

S403. The access point sends, in the first TWT service period, the IoT indication frame through a channel used by the IoT station, to trigger access and transmission performed by the IoT station.

When the IoT indication framesare periodic transmission, the IoT indication frame may carry second indication information, and the second indication information is used to indicate a transmission period of the IoT indication frame, so that the IoT station calculates a subsequent transmission time of the IoT indication subframe based on a time at which the IoT indication frame is received and the transmission period.

When the IoT station performs temporary (or in other words, non-periodic) transmission, the IoT indication frame may carry third indication information, and the third indication information is used to indicate a transmission time of a next IoT indication frame. Optionally, the next IoT indication frame and the current IoT indication frame may be separated by at least one ax beacon frame, so that the access point indicates the transmission time of the next IoT indication frame to the ax station by using the at least one ax beacon frame, and the ax station can effectively avoid a communication time of the IoT station.

Optionally, the IoT indication frame may further carry fourth indication information, and the fourth indication information is used to indicate a transmission time or a transmission period of the ax beacon frame, to instruct the IoT station to avoid the transmission time or the transmission period of the ax station.

Optionally, the IoT station may sleep before the IoT indication frame arrives, and the ax station may sleep during an IoT operating time reserved by the IoT Indication frame.

In this embodiment of this application, the access point indicates, in the ax beacon frame, to the ax station that the IoT station operates in the first TWT service period; and sends, to the IoT station in the first TWT service period, the IoT indication frame for scheduling the second-type station set, so that the ax station avoids the operating time of the IoT station, thereby preventing the two types of stations from interfering with each other and improving communication quality.

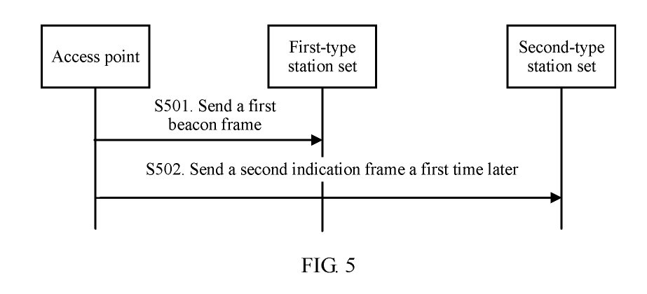

The communication method in the embodiments of this application is described above with reference to FIG. 1 to FIG. 4. Another communication method 500 and still another communication method 600 in the embodiments of this application are described below with reference to FIG. 5 and FIG. 6. The method 500 may be applied to the application scenario in FIG. 1. For content in the method 500 same as or similar to content in the method 200, refer to the corresponding content in the method 200. For brevity, details are not described herein again. The method 500 includes the following steps.

S501. An access point sends a first beacon frame, where the first beacon frame is used to schedule a first-type station set.

Optionally, the first-type station set may be a set including a WLAN station. The WLAN station may be a station in an 802.11ax standard for a wireless local area network. The first beacon frame may be a beacon frame in an 801.11ax standard.

S502. The access point sends a second indication frame a first time later after sending the first beacon frame, where the second indication frame is used to schedule a second-type station set, the first time is less than a time required by the first-type station set to send data, and a bandwidth specification of a physical packet carrying a beacon frame for scheduling the first-type station set is different from a bandwidth specification of a physical packet carrying an indication frame for scheduling the second-type station set.

Optionally, to prevent the access point from being interfered with by the first-type station set when sending the second indication frame to the second-type station set, in this embodiment of this application, the access point may send the second indication frame to the second-type station set the first time later after sending the first beacon frame to the first-type station set. The first time is less than the time required by the first-type station set to send data. Therefore, after the first time, there is not enough time for the first-type station set to send data to the access point. In this case, a channel cannot be used by a second-type station. Therefore, the access point sends the second indication frame to the second-type station set the first time later, so that it can be ensured that the second-type station set receives the second indication frame without being interfered with by the first-type station set.

Optionally, the first time may be a short inter-frame space (Short Inter-frame Space, SIFS), a point coordination function inter-frame space (Point Coordination Function Inter-frame Space, PIFS), or another time interval. For example, the first time may be represented by using an XIFS, and the XIFS represents a time interval.

Optionally, the second indication frame may be indication frames, on a plurality of different frequency bands, for scheduling the second-type station set. The access point may simultaneously send, on a plurality of different frequency bands, indication frames for scheduling the second-type station set; may send, on different frequency bands at different times, that is, at a time interval, indication frames for scheduling the second-type station set; or may use a manner that combines the two methods.

Optionally, the first beacon frame and the second indication frame may be sent based on a period. In addition, transmission periods of the two frames may meet the following condition: the transmission period of the indication frame for scheduling the second-type station set is N times the transmission period of the beacon frame for scheduling the first-type station set, and N is a positive integer greater than 1.

In this embodiment of this application, to further ensure that the second-type station set is not interfered with by the first-type station set during an operating time, the access point may send, before sending the second indication frame, a control signal through a channel used by the first-type station set, to occupy the channel, so that a first-type station cannot transmit data through the channel, thereby ensuring that a second-type station can send the second indication frame and other data through the channel without being interfered with.

Optionally, in an example, in the method 500, before the access point sends the second indication frame, the communication method further includes the following: The access point sends a control signal through a channel used by the first-type station set. The control signal is used to indicate to the first-type station set that the channel is occupied in a second time, and the second time includes a time used by the access point to send the second indication frame.

Optionally, there may be a plurality of methods for occupying the channel.

In a manner, the control signal may be carried in a preamble. For example, the preamble may be control information in a legacy preamble (English: legacy preamble). For example, the control information may be located in a length field of the legacy preamble. When the first-type station is a WLAN station, the legacy preamble may be a legacy preamble compatible with a WLAN technology.

In another manner, the control signal may be used to set a network allocation vector (Network Allocation Vector, NAV), and the network allocation vector is set to “occupy the channel in the second time”.

Optionally, the control signal used to set the NAV may be of a plurality of types. For example, the control signal may be any one of the following signals: a request to send (Request to Send, RTS) frame, a multi-user request to send (Multi-user RTS, MU-RTS) frame, and a clear to send-to-self (Clear to Send-to-self, CTS-to-self) frame.

Optionally, the second indication frame may also indicate a communication time of the first-type station set to the second-type station set, so that the second-type station set avoids the communication time.

In an example, the second indication frame may include fifth indication information, and the fifth indication information is used to indicate, to the second-type station set, a transmission time of a beacon frame for scheduling the first-type station set. For example, the fifth indication information may indicate the transmission period of the beacon frame for scheduling the first-type station set, so that the second-type station set calculates, based on the transmission time and the transmission period, a next transmission time of the beacon frame for scheduling the first-type station set, and effectively avoids the transmission time.

For another example, the second indication frame may include sixth indication information, and the sixth indication information is used to indicate, to the second-type station set, a communication time range of the first-type station set.

In this embodiment of this application, the communication time range of the first-type station set is indicated to the second-type station set, so that the second-type station set avoids a communication time of a first-type station after receiving the second indication frame. This helps coordinate avoidance between the first-type station set and the second-type station set, thereby improving communication quality.

A specific example of the embodiments of this application is described below in detail with reference to FIG. 6. FIG. 6 shows the communication method 600 according to an embodiment of this application. In the communication method 600, it is assumed that a first-type station is a station in an 801.11ax standard (referred to as an ax station for short) and that a second-type station set is an Internet of Things station (referred to as an IoT station for short). In this case, a beacon frame for scheduling the first-type station set may be referred to as an ax beacon frame, and an indication frame for scheduling the second-type station set may be referred to as an IoT indication frame. The IoT indication frame may be a beacon frame or a trigger frame. The ax station uses a broadband to perform transmission, and the IoT station uses a narrowband to perform transmission. The communication method 600 includes the following steps:

S601. An access point sends an ax beacon frame.

S602. As shown in Manner 1 in FIG. 6, the access point sends, an XIFS later after sending the ax beacon frame, a preamble compatible with the ax station through a channel (for example, a channel of 20 MHz or over 20 MHz) used by the ax station, to occupy the channel used by the ax station, so that the ax station does not cause interference to data transmission between the access point and the IoT station during a second time. The second time includes a time used by the access point to send a IoT indication frame described below.

Optionally, as shown in Manner 2 in FIG. 6, the access point may send an RTS frame, an MU-RTS frame, or a CTS-to-self frame to set a network allocation vector, to occupy the channel used by the ax station.

S603. After occupying the channel, the access point sends an IoT indication frame.

Optionally, as shown in Manner 1 and Manner 2, the IoT indication frame may be IoT indication frames on a plurality of different frequency bands. The access point may simultaneously send IoT indication frames on a plurality of different frequency bands; may send IoT indication frames on different bands at different times, that is, at a time interval, or may use a manner that combines the two methods.

Optionally, a transmission period of the IoT indication frame may be an integer multiple of a transmission period of the ax beacon frame. For example, as shown in FIG. 6, the transmission period of the IoT indication frame may be twice the transmission period of the ax beacon frame.

Optionally, a transmission time of the ax beacon frame may also be reserved in the IoT indication frame. For example, the IoT indication frame may be used to indicate a starting time and the transmission period of the ax beacon frame, so that the IoT station avoids the starting time and the transmission time of the ax beacon frame.

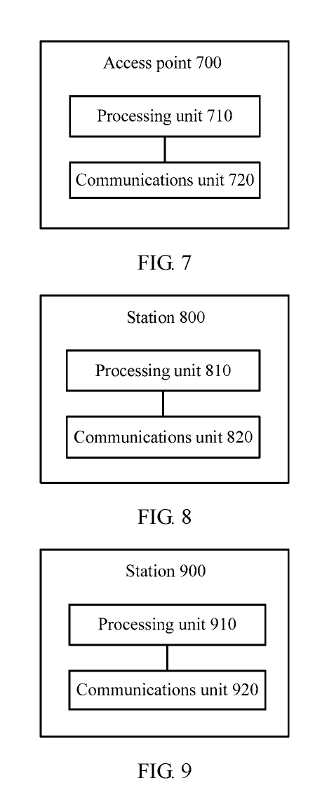

The communication method in the embodiments of this application is described above with reference to FIG. 1 to FIG. 6. An access point and a station in the embodiments of this application are described below in detail with reference to FIG. 7 to FIG. 16.

FIG. 7 shows an access point 700 according to an embodiment of this application. The access point 700 may perform the steps performed by the access point in the methods in FIG. 2 to FIG. 4. The access point 700 includes a processing unit 710 and a communications unit 720.

The processing unit 710 is configured to: send a first beacon frame by using the communications unit 720, where the first beacon frame is used to schedule a first-type station set, a target wake time TWT information element in the first beacon frame includes first indication information, and the first indication information is used to indicate to the first-type station set that a first TWT service period is provided to a second-type station set for use; and

send a second indication frame in the first TWT service period by using the communications unit 720, where the second indication frame is used to schedule the second-type station set, and a bandwidth specification of a physical packet carrying a beacon frame for scheduling the first-type station set is different from a bandwidth specification of a physical packet carrying an indication frame for scheduling the second-type station set.

In this embodiment of this application, the access point indicates, to the first-type station set in the first beacon frame, the first TWT service period in which the second-type station set operates; and sends, to the second-type station set in the first TWT service period, the second indication frame for scheduling the second-type station set, so that the first-type station set avoids an operating time of the second-type station set, thereby preventing the two types of stations from interfering with each other and improving communication quality.

It should be understood that the apparatus 700 is embodied in a form of a function unit herein. The term “unit” herein may be an application-specific integrated circuit (Application-Specific Integrated Circuit, ASIC), an electronic circuit, a processor (for example, a shared processor, a dedicated processor, or a group processor) configured to execute one or more software or firmware programs and a memory, or a combinational logic circuit and/or another appropriate component supporting the described functions. In an optional example, a person of ordinary skill in the art can understand that the apparatus 700 may be specifically the access point in the foregoing embodiments, and the apparatus 700 may be configured to perform the procedures and/or steps corresponding to the access point in the foregoing method embodiments. To avoid repetition, details are not described herein.

FIG. 8 shows a station 800 according to an embodiment of this application. The station 800 may perform the steps performed by a station in the first-type station set in the methods in FIG. 2 to FIG. 4. The station 800 includes a processing unit 810 and a communications unit 820.

The processing unit 810 is configured to: receive, by using the communications unit 820, a first beacon frame sent by an access point, where the first beacon frame is used to schedule the first-type station set, a target wake time TWT information element in the first beacon frame includes first indication information, the first indication information is used to indicate to the first-type station set that a first TWT service period is provided to a second-type station set for use, and a bandwidth specification of a physical packet carrying a beacon frame for scheduling the first-type station set is different from a bandwidth specification of a physical packet carrying an indication frame for scheduling the second-type station set; and perform communication based on the first beacon frame by using the communications unit 820.

In this embodiment of this application, the access point indicates, to the first-type station set in the first beacon frame, the first TWT service period in which the second-type station set operates, so that the first-type station set avoids an operating time of the second-type station set, thereby preventing the two types of stations from interfering with each other and improving communication quality.

It should be understood that the apparatus 800 is embodied in a form of a function unit herein. The term “unit” herein may be an application-specific integrated circuit (Application-Specific Integrated Circuit, ASIC), an electronic circuit, a processor (for example, a shared processor, a dedicated processor, or a group processor) configured to execute one or more software or firmware programs and a memory, or a combinational logic circuit and/or another appropriate component supporting the described functions. In an optional example, a person of ordinary skill in the art can understand that the apparatus 800 may be specifically the station in the first-type station set in the foregoing embodiments, and the apparatus 800 may be configured to perform the procedures and/or steps corresponding to the station in the first-type station set in the foregoing method embodiments. To avoid repetition, details are not described herein.

FIG. 9 shows a station 900 according to an embodiment of this application. The station 900 may perform the steps performed by a station in the second-type station set in the methods in FIG. 2 to FIG. 4. The station 900 includes a processing unit 910 and a communications unit 920.

The processing unit 910 is configured to: receive, by using the communications unit 920, a second indication frame sent by an access point, where the second indication frame is used to schedule the second-type station set, the second indication frame includes fourth indication information, the fourth indication information is used to indicate to the second-type station set that a second TWT service period is provided to a first-type station set for use, and a bandwidth specification of a physical packet carrying a beacon frame for scheduling the first-type station set is different from a bandwidth specification of a physical packet carrying an indication frame for scheduling the second-type station set; and perform communication based on the second indication frame by using the communications unit 920.

In this embodiment of this application, the access point indicates, to the second-type station set in the second indication frame, the second TWT service period in which the first-type station set operates, so that the second-type station set avoids an operating time of the first-type station set, thereby preventing the two types of stations from interfering with each other and improving communication quality.

It should be understood that the apparatus 900 is embodied in a form of a function unit herein. The term “unit” herein may be an application-specific integrated circuit (Application-Specific Integrated Circuit, ASIC), an electronic circuit, a processor (for example, a shared processor, a dedicated processor, or a group processor) configured to execute one or more software or firmware programs and a memory, or a combinational logic circuit and/or another appropriate component supporting the described functions. In an optional example, a person of ordinary skill in the art can understand that the apparatus 900 may be specifically the station in the second-type station set in the foregoing embodiments, and the apparatus 900 may be configured to perform the procedures and/or steps corresponding to the station in the second-type station set in the foregoing method embodiments. To avoid repetition, details are not described herein.

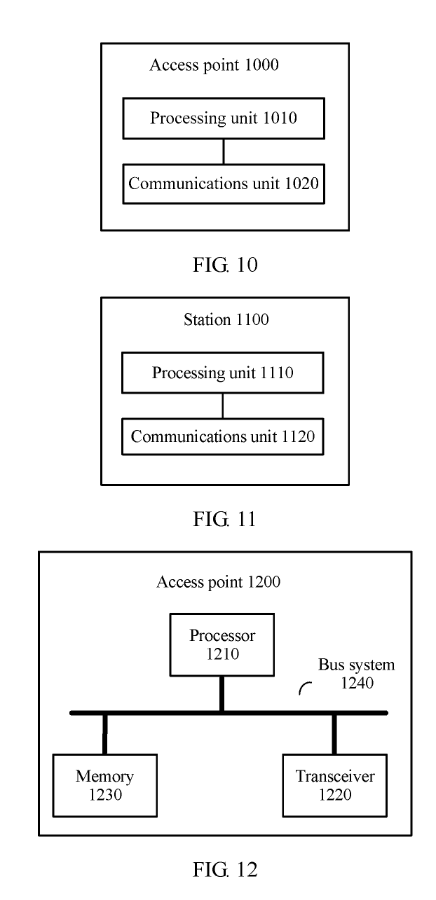

FIG. 10 shows an access point 1000 according to an embodiment of this application. The access point 1000 may perform steps performed by the access point in the methods in FIG. 5 and FIG. 6. The access point 1000 includes a processing unit 1010 and a communications unit 1020.

the processing unit 1010 is configured to: send a first beacon frame by using the communications unit 1020, where the first beacon frame is used to schedule a first-type station set; and

send, by using the communications unit 1020, a second indication frame a first time later after sending the first beacon frame, where the second indication frame is used to schedule a second-type station set, the first time is less than a time required by the first-type station set to send data, and a bandwidth specification of a physical packet carrying a beacon frame for scheduling the first-type station set is different from a bandwidth specification of a physical packet carrying an indication frame for scheduling the second-type station set.

In this embodiment of this application, to prevent the access point from being interfered with by the first-type station set when sending the second indication frame to the second-type station set, the access point sends the second indication frame to the second-type station set the first time later after sending the first beacon frame to the first-type station set. The first time is less than the time required by the first-type station set to send data. Therefore, after the first time, there is not enough time for the first-type station set to send data to the access point. In this case, a channel cannot be used by a second-type station. Therefore, the access point sends the second indication frame to the second-type station set the first time later, so that it can be ensured that the second-type station set receives the second indication frame without being interfered with by the first-type station set.

It should be understood that the apparatus 1000 is embodied in a form of a function unit herein. The term “unit” herein may be an application-specific integrated circuit (Application-Specific Integrated Circuit, ASIC), an electronic circuit, a processor (for example, a shared processor, a dedicated processor, or a group processor) configured to execute one or more software or firmware programs and a memory, or a combinational logic circuit and/or another appropriate component supporting the described functions. In an optional example, a person of ordinary skill in the art can understand that the apparatus 1000 may be specifically the access point in the foregoing embodiments, and the apparatus 1000 may be configured to perform the procedures and/or steps corresponding to the access point in the foregoing method embodiments. To avoid repetition, details are not described herein.

FIG. 11 shows a station 1100 according to an embodiment of this application. The station 1100 may perform the steps performed by a station in the second-type station set in the method in FIG. 5 or FIG. 6. The station 1100 includes a processing unit 1110 and a communications unit 1120.

The processing unit 1110 is configured to: receive, by using the communications unit 1120, a second indication frame sent by an access point, where the second indication frame is used to schedule the second-type station set, the second indication frame includes fifth indication information, the fifth indication information is used to indicate, to the second-type station set, a transmission time of a beacon frame for scheduling a first-type station set, and a bandwidth specification of a physical packet carrying the beacon frame for scheduling the first-type station set is different from a bandwidth specification of a physical packet carrying an indication frame for scheduling the second-type station set; and perform communication based on the second indication frame by using the communications unit 1120.

In this embodiment of this application, the access point indicates, to the second-type station set in the second indication frame, a second TWT service period in which the first-type station set operates, so that the second-type station set avoids an operating time of the first-type station set, thereby preventing the two types of stations from interfering with each other and improving communication quality.

It should be understood that the apparatus 1100 is embodied in a form of a function unit herein. The term “unit” herein may be an application-specific integrated circuit (Application-Specific Integrated Circuit, ASIC), an electronic circuit, a processor (for example, a shared processor, a dedicated processor, or a group processor) configured to execute one or more software or firmware programs and a memory, or a combinational logic circuit and/or another appropriate component supporting the described functions. In an optional example, a person of ordinary skill in the art can understand that the apparatus 1100 may be specifically the station in the second-type station set in the foregoing embodiments, and the apparatus 1100 may be configured to perform the procedures and/or steps corresponding to the station in the second-type station set in the foregoing method embodiments. To avoid repetition, details are not described herein.

FIG. 12 shows another access point 1200 according to an embodiment of this application. The access point 1200 includes a processor 1210, a transceiver 1220, a memory 1230, and a bus system 1240. The processor 1210, the transceiver 1220, and the memory 1230 are connected by using the bus system 1240. The memory 1230 is configured to store an instruction. The processor 1210 is configured to execute the instruction stored in the memory 1230, to control the transceiver 1220 to send a signal and/or receive a signal.

The processor 1210 is configured to send a first beacon frame by using the transceiver 1220, where the first beacon frame is used to schedule a first-type station set, a target wake time TWT information element in the first beacon frame includes first indication information, and the first indication information is used to indicate to the first-type station set that a first TWT service period is provided to a second-type station set for use; and send a second indication frame in the first TWT service period by using the transceiver 1220, where the second indication frame is used to schedule the second-type station set, and a bandwidth specification of a physical packet carrying a beacon frame for scheduling the first-type station set is different from a bandwidth specification of a physical packet carrying an indication frame for scheduling the second-type station set.

It should be understood that the access point 1200 may be specifically the access point in the foregoing embodiments in FIG. 2 to FIG. 4, and may be configured to perform the steps and/or procedures corresponding to the access point in the foregoing method embodiments. Optionally, the memory 1230 may include a read-only memory and a random access memory, and provide an instruction and data to the processor. A part of the memory may further include a non-volatile random access memory. For example, the memory may further store device type information. The processor 1210 may be configured to execute the instruction stored in the memory. In addition, when the processor 1210 executes the instruction stored in the memory, the processor 1210 is configured to perform the steps and/or procedures corresponding to the access point in the foregoing method embodiments.

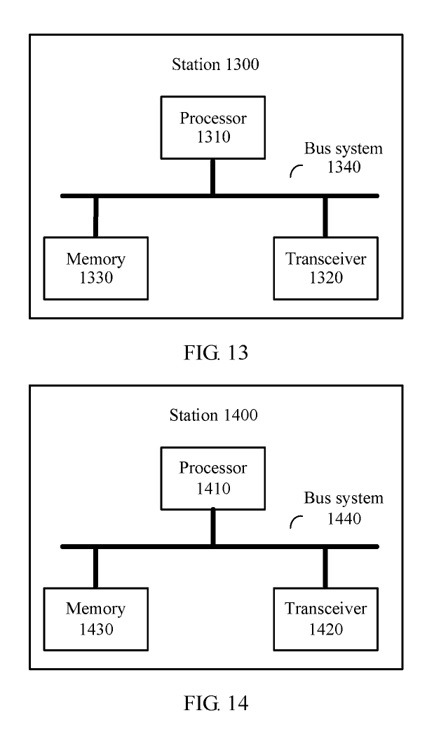

FIG. 13 shows another station 1300 according to an embodiment of this application. The station 1300 includes a processor 1310, a transceiver 1320, a memory 1330, and a bus system 1340. The processor 1310, the transceiver 1320, and the memory 1330 are connected by using the bus system 1340. The memory 1330 is configured to store an instruction. The processor 1310 is configured to execute the instruction stored in the memory 1330, to control the transceiver 1320 to send a signal and/or receive a signal.

The processor 1310 is configured to: receive, by using the transceiver 1320, a first beacon frame sent by an access point, where the first beacon frame is used to schedule a first-type station set, a target wake time TWT information element in the first beacon frame includes first indication information, the first indication information is used to indicate to the first-type station set that a first TWT service period is provided to a second-type station set for use, and a bandwidth specification of a physical packet carrying a beacon frame for scheduling the first-type station set is different from a bandwidth specification of a physical packet carrying an indication frame for scheduling the second-type station set; and perform communication based on the first beacon frame by using the transceiver 1320.

It should be understood that the station 1300 may be specifically a station in the first-type station set in the foregoing embodiments in FIG. 2 to FIG. 4, and may be configured to perform the steps and/or procedures corresponding to the station in the first-type station set in the foregoing method embodiments. Optionally, the memory 1330 may include a read-only memory and a random access memory, and provide an instruction and data to the processor. A part of the memory may further include a non-volatile random access memory. For example, the memory may further store device type information. The processor 1310 may be configured to execute the instruction stored in the memory. In addition, when the processor 1310 executes the instruction stored in the memory, the processor 1310 is configured to perform the steps and/or procedures corresponding to the station in the first-type station set in the foregoing method embodiments.

FIG. 14 shows another station 1400 according to an embodiment of this application. The station 1400 includes a processor 1410, a transceiver 1420, a memory 1430, and a bus system 1440. The processor 1410, the transceiver 1420, and the memory 1430 are connected by using the bus system 1440. The memory 1430 is configured to store an instruction. The processor 1410 is configured to execute the instruction stored in the memory 1430, to control the transceiver 1420 to send a signal and/or receive a signal.

The processor 1410 is configured to: receive, by using the transceiver 1420, a second indication frame sent by an access point, where the second indication frame is used to schedule a second-type station set, the second indication frame includes fourth indication information, the fourth indication information is used to indicate to the second-type station set that a second TWT service period is provided to a first-type station set for use, and a bandwidth specification of a physical packet carrying a beacon frame for scheduling the first-type station set is different from a bandwidth specification of a physical packet carrying an indication frame for scheduling the second-type station set; and perform communication based on the second indication frame by using the transceiver 1420.

It should be understood that the station 1400 may be specifically a station in the second-type station set in the foregoing embodiments in FIG. 2 to FIG. 4, and may be configured to perform the steps and/or procedures corresponding to the station in the second-type station set in the foregoing method embodiments. Optionally, the memory 1430 may include a read-only memory and a random access memory, and provide an instruction and data to the processor. A part of the memory may further include a non-volatile random access memory. For example, the memory may further store device type information. The processor 1410 may be configured to execute the instruction stored in the memory. In addition, when the processor 1410 executes the instruction stored in the memory, the processor 1410 is configured to perform the steps and/or procedures corresponding to the station in the second-type station set in the foregoing method embodiments.

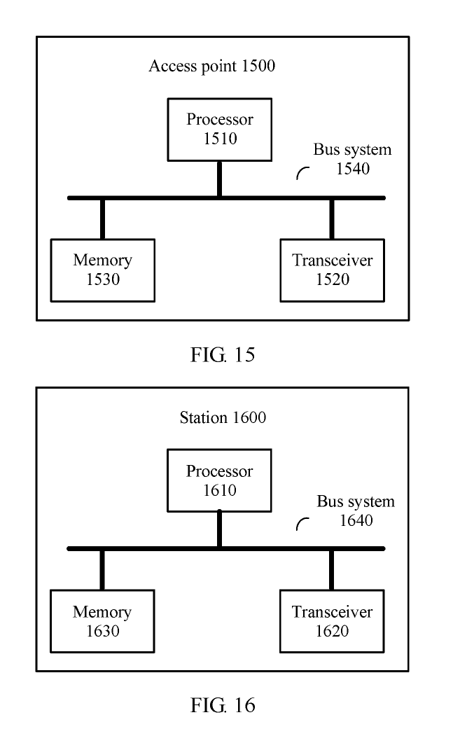

FIG. 15 shows another access point 1500 according to an embodiment of this application. The access point 1500 includes a processor 1510, a transceiver 1520, a memory 1530, and a bus system 1540. The processor 1510, the transceiver 1520, and the memory 1530 are connected by using the bus system 1540. The memory 1530 is configured to store an instruction. The processor 1510 is configured to execute the instruction stored in the memory 1530, to control the transceiver 1520 to send a signal and/or receive a signal.

The processor 1510 is configured to send a first beacon frame by using the transceiver 1520, where the first beacon frame is used to schedule a first-type station set; and send, by using the transceiver 1520, a second indication frame a first time later after sending the first beacon frame, where the second indication frame is used to schedule a second-type station set, the first time is less than a time required by the first-type station set to send data, and a bandwidth specification of a physical packet carrying a beacon frame for scheduling the first-type station set is different from a bandwidth specification of a physical packet carrying an indication frame for scheduling the second-type station set.

It should be understood that the access point 1500 may be specifically the access point in the foregoing embodiment in FIG. 5 or FIG. 6, and may be configured to perform the steps and/or procedures corresponding to the access point in the foregoing method embodiments. Optionally, the memory 1530 may include a read-only memory and a random access memory, and provide an instruction and data to the processor. A part of the memory may further include a non-volatile random access memory. For example, the memory may further store device type information.

The processor 1510 may be configured to execute the instruction stored in the memory. In addition, when the processor 1510 executes the instruction stored in the memory, the processor 1510 is configured to perform the steps and/or procedures corresponding to the access point in the foregoing method embodiments.

FIG. 16 shows another station 1600 according to an embodiment of this application. The station 1600 includes a processor 1610, a transceiver 1620, a memory 1630, and a bus system 1640. The processor 1610, the transceiver 1620, and the memory 1630 are connected by using the bus system 1640. The memory 1630 is configured to store an instruction. The processor 1610 is configured to execute the instruction stored in the memory 1630, to control the transceiver 1620 to send a signal and/or receive a signal.

The processor 1610 is configured to: receive, by using the transceiver 1620, a second indication frame sent by an access point, where the second indication frame is used to schedule a second-type station set, the second indication frame includes fifth indication information, the fifth indication information is used to indicate, to the second-type station set, a transmission time of a beacon frame for scheduling a first-type station set, and a bandwidth specification of a physical packet carrying a beacon frame for scheduling the first-type station set is different from a bandwidth specification of a physical packet carrying an indication frame for scheduling the second-type station set; and perform communication based on the second indication frame by using the transceiver 1620.

It should be understood that the station 1600 may be specifically a station in the second-type station set in the foregoing embodiment in FIG. 5 or FIG. 6, and may be configured to perform the steps and/or procedures corresponding to the station in the second-type station set in the foregoing method embodiments. Optionally, the memory 1630 may include a read-only memory and a random access memory, and provide an instruction and data to the processor. A part of the memory may further include a non-volatile random access memory. For example, the memory may further store device type information. The processor 1610 may be configured to execute the instruction stored in the memory. In addition, when the processor 1610 executes the instruction stored in the memory, the processor 1610 is configured to perform the steps and/or procedures corresponding to the station in the second-type station set in the foregoing method embodiments.

In addition, the terms “system” and “network” may be used interchangeably in this specification. The term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

It should be understood that in the embodiments of this application, “B corresponding to A” indicates that B is associated with A, and B may be determined according to A. However, it should also be understood that determining B according to A does not mean that B is determined according to A only, and B may also be determined according to A and/or other information.

A person of ordinary skill in the art may be aware that the units and algorithm steps in the examples described with reference to the embodiments disclosed in this specification can be implemented by electronic hardware, computer software, or a combination thereof To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that for the purpose of convenient and brief description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communications connections may be implemented through some interfaces, indirect couplings or communication connections between the apparatuses or units, electrical connections, mechanical connections, or connections in other forms.

The units described as separate parts may or may not be physically separate, and parts displayed as units may or may not be physical units, may be located in one position, or may be distributed on a plurality of network units. Some or all of the units may be selected based on actual needs to achieve the objectives of the solutions of the embodiments of this application.

In addition, the function units in the embodiments of this application may be integrated into one processing unit, or each of the units may exist alone physically, or two or more units are integrated into one unit. The integrated unit may be implemented in a form of hardware, or may be implemented in a form of a software function unit.

When the integrated unit is implemented in the form of a software function unit and sold or used as an independent product, the integrated unit may be stored in a computer readable storage medium. Based on such an understanding, the technical solutions of this application essentially, or the part contributing to the prior art, or all or some of the technical solutions may be implemented in the form of a software product. The computer software product is stored in a storage medium and includes several instructions for instructing a computer device (which may be a personal computer, a server, a network device, or the like) to perform all or some of the steps of the methods described in the embodiments of this application. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

To make the application document brief and clear, technical features and descriptions in one of the foregoing embodiments may be considered to be applicable to other embodiments, and details are not described in the other embodiments.

The foregoing descriptions are merely specific implementations of this application, but are not intended to limit the protection scope of this application. Any equivalent modification or replacement readily figured out by a person skilled in the art within the technical scope disclosed in this application shall fall within the protection scope of this application. Therefore, the protection scope of this application shall be subject to the protection scope of the claims.

What is claimed is:

1. An apparatus, the apparatus comprising at least one processor and a memory configured to store executable program code, wherein when the at least one processor invokes the executable program code stored in the memory, the at least one processor is configured to:
send a first beacon frame, wherein the first beacon frame is used to schedule a first-type station set, wherein a target wake time (TWT) information element in the first beacon frame comprises first indication information, and wherein the first indication information is used to indicate to the first-type station set that a first TWT service period is provided to a second-type station set for use; and
send a second indication frame in the first TWT service period, wherein the second indication frame is used to schedule the second-type station set, and wherein a bandwidth specification of a physical packet carrying a beacon frame for scheduling the first-type station set is different from a bandwidth specification of a physical packet carrying an indication frame for scheduling the second-type station set.

2. The apparatus according to claim 1, wherein before sending the second indication frame, the at least one processor is further configured to send a control signal through a channel used by the first-type station set, wherein the control signal is used to indicate to the first-type station set that the channel is occupied in a second time, and wherein the second time comprises the first TWT service period.

3. The apparatus according to claim 2, wherein the control signal is control information carried in a preamble.

4. The apparatus according to claim 2, wherein the control signal is used to set a network allocation vector to occupy the channel in the second time.

5. The apparatus according to claim 1, wherein the second indication frame comprises second indication information, and wherein the second indication information is used to indicate a transmission period of an indication frame for scheduling the second-type station set.

6. The apparatus according to claim 1, wherein the second indication frame comprises third indication information, and wherein the third indication information is used to indicate a transmission time of a next indication frame for scheduling the second-type station set.

7. The apparatus according to claim 6, wherein the next indication frame and the second indication frame are separated by at least one beacon frame, and wherein the at least one beacon frame is a beacon frame for scheduling the first-type station set.

8. The apparatus according to claim 1, wherein the second indication frame comprises fourth indication information, and wherein the fourth indication information is used to indicate to the second-type station set that a second TWT service period is provided to the first-type station set for use.

9. The apparatus according to claim 1, wherein the second-type station set comprises an Internet of Things station.

10. The apparatus according to claim 1, wherein a bandwidth of a physical packet carrying the first beacon frame is greater than or equal to 20 MHz, and wherein a bandwidth of a physical packet carrying the second indication frame is less than 20 MHz.

11. An apparatus, applied into a station, wherein the station is a station in a first-type station set, wherein the apparatus comprises at least one processor and a memory configured to store executable program code, and wherein when the at least one processor invokes the executable program code stored in the memory, the at least one processor is configured to:
receive a first beacon frame sent by an access point, wherein the first beacon frame is used to schedule the first-type station set, wherein a target wake time TWT information element in the first beacon frame comprises first indication information, wherein the first indication information is used to indicate to the first-type station set that a first TWT service period is provided to a second-type station set for use, and wherein a bandwidth specification of a physical packet carrying a beacon frame for scheduling the first-type station set is different from a bandwidth specification of a physical packet carrying an indication frame for scheduling the second-type station set; and
perform communication based on the first beacon frame.

12. The apparatus according to claim 11, wherein the at least one processor is further configured to receive, through a channel used by the first-type station set, a control signal sent by the access point, wherein the control signal is used to indicate to the first-type station set that the channel is occupied in a second time, and wherein the second time comprises the first TWT service period.

13. The apparatus according to claim 12, wherein the control signal is control information carried in a preamble.

14. The apparatus according to claim 12, wherein the control signal is used to set a network allocation vector to occupy the channel in the second time.

15. The apparatus according to claim 11, wherein the second-type station set comprises an Internet of Things station.

16. An apparatus, applied into a station, wherein the station is a station in a second-type station set, wherein the apparatus comprises at least one processor and a memory configured to store executable program code, and wherein when the at least one processor invokes the executable program code stored in the memory, the at least one processor is configured to:
receive a second indication frame sent by an access point, wherein the second indication frame is used to schedule the second-type station set, wherein the second indication frame comprises fourth indication information, wherein the fourth indication information is used to indicate to the second-type station set that a second TWT service period is provided to a first-type station set for use, and wherein a bandwidth specification of a physical packet carrying a beacon frame for scheduling the first-type station set is different from a bandwidth specification of a physical packet carrying an indication frame for scheduling the second-type station set; and
perform communication based on the second indication frame.

17. The apparatus according to claim 16, wherein the second indication frame comprises second indication information, and wherein the second indication information is used to indicate a transmission period of an indication frame for scheduling the second-type station set.

18. The apparatus according to claim 16, wherein the second indication frame comprises third indication information, and wherein the third indication information is used to indicate a transmission time of a next indication frame for scheduling the second-type station set.

19. The apparatus according to claim 16, wherein the second-type station set comprises an Internet of Things station.

20. The apparatus according to claim 16, wherein a bandwidth of a physical packet carrying the second indication frame is less than 20 MHz.
